(19) United States
(12) Patent Application Publication
(10) Pub. No.: US 2010/0277118 A1
(43) Pub. Date: Nov. 4, 2010

(54) AUTOMATED POWER SUPPLY

(76) Inventors: Yen-Hui WANG, Hsinchu City (TW); Chih-Hung Yang, Tainan City (TW)

Correspondence Address: NORTH AMERICA INTELLECTUAL PROPERTY CORPORATION, P.O. BOX 506, MERRIFIELD, VA, 22116, US

(21) Appl. No.: 12/434,914

(22) Filed: May 4, 2009

(51) Int. Cl. H02J 7/00

(52) U.S. Cl. 320/103

(57) ABSTRACT

An automated power supply is formed primarily by electrically connecting a power supply system and a chip management module. The chip management module includes a data storage module, a transmission module, a protocol circuit module and a power detecting module. The protocol circuit module includes at least one power output/input pin for transmitting an electric signal, and a grounding pin. Therefore, not only a requirement of an internal driving power can be reduced, but also a size of the chip and electric power consumption can be diminished significantly.

### BACKGROUND OF THE INVENTION

a) Field of the Invention

The present invention relates to a power supply, and more particularly to an automated power supply which conducts recharging by using a voltage difference between pins.

b) Description of the Prior Art

Following continuous advancement of technologies, 3C (Computing, Communication and Consumer) products are more and more versatile. As the 3C products sold by each vendor will have different recharging devices, in order to allow one recharging device to recharge all kinds of 3C products, a consumer will need to purchase additionally a recharger which can adjust a voltage. However, not only this voltage adjustable recharger is large in size that it is inconvenient to carry, but also an entire cost is too high that a selling price will be expensive correspondingly. Therefore, in view of that a multi-voltage consumer electronic product has come out, it is apparently that how to aggressively control the cost, how to extend of a lifetime of usage of a battery, how to provide compatibility of the product and how to reduce electric power consumption have become technological issues of research and development for improvement by the present inventor and related vendors.

### SUMMARY OF THE INVENTION

The primary object of the present invention is to provide an automated power supply which is formed primarily by electrically connecting a power supply system with a chip management module, wherein the chip management module includes a data storage module, a transmission module, a protocol circuit module and a power detecting module. As the protocol circuit module is provided with at least one power output/input pin to transmit an electric signal and one grounding pin, a capacitor module inside the chip management module will perform recharging through a voltage difference between the pins. Before the power detecting module has detected that the voltage of the capacitor module reaches to a rated value, the system will be resting. On the other hand, after the power detecting module has detected that the voltage reaches to the rated value, the protocol circuit module will output the electric signal through the transmission module or response to a protocol transmission/receiving module to output the electric signal. Therefore, in addition to that a requirement of an internal driving power can be reduced; a size of the chip and electric power consumption can be diminished significantly.

Another object of the present invention is to provide an automated power supply, wherein, as a number of pins is largely decreased, the size of chip is relatively diminished significantly, which will also reduce electric power consumption at a same time.

Still another object of the present invention is to provide an automated power supply, wherein, as this system can supply a proper voltage to an electronic product, a lifetime of usage of a battery can be extended. Furthermore, as a highly compatible connection port is used on a transmission interface, convenience of usage can be improved correspondingly.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a state of the present invention which supplies a proper power specification to an electronic product.

FIG. 2 shows an internal schematic view of a chip management module of the present invention.

FIG. 3 shows a flow diagram of a power supply of the present invention.

FIG. 4 shows a schematic view of a state of another embodiment of the present invention which supplies a proper power specification to an electronic product.

FIG. 5 shows an internal schematic view of a chip management module of another embodiment of the present invention, wherein the chip management module uses two power output pins to proceed with signal transmission.

FIG. 6 shows a schematic view of a chip management module of still another embodiment of the present invention, wherein the chip management module responses to a protocol transmission/receiving module and outputs an electric signal.

FIG. 7 shows an internal schematic view of the chip management module in FIG. 6.

FIG. 8 shows a flow diagram of FIG. 6.

### DETAILED DESCRIPTION OF THE PREFERRED EMBODIMENTS

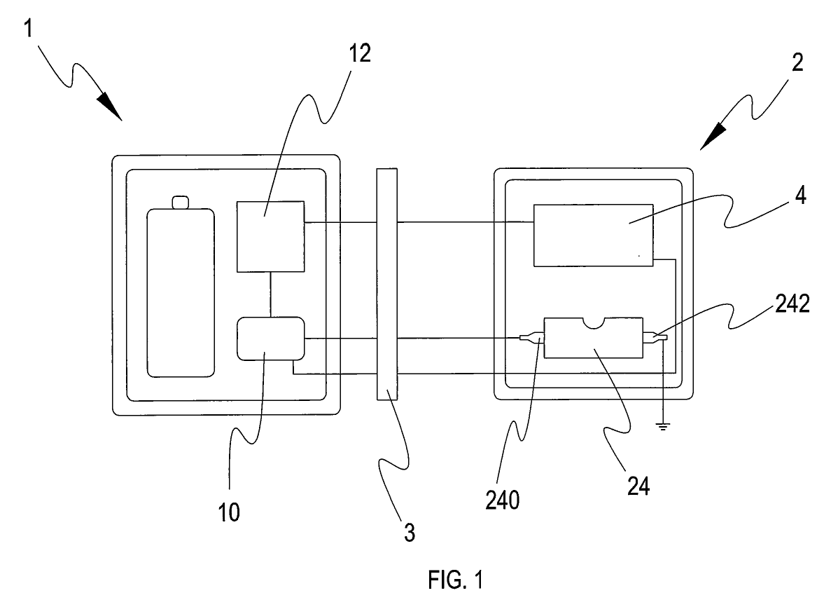

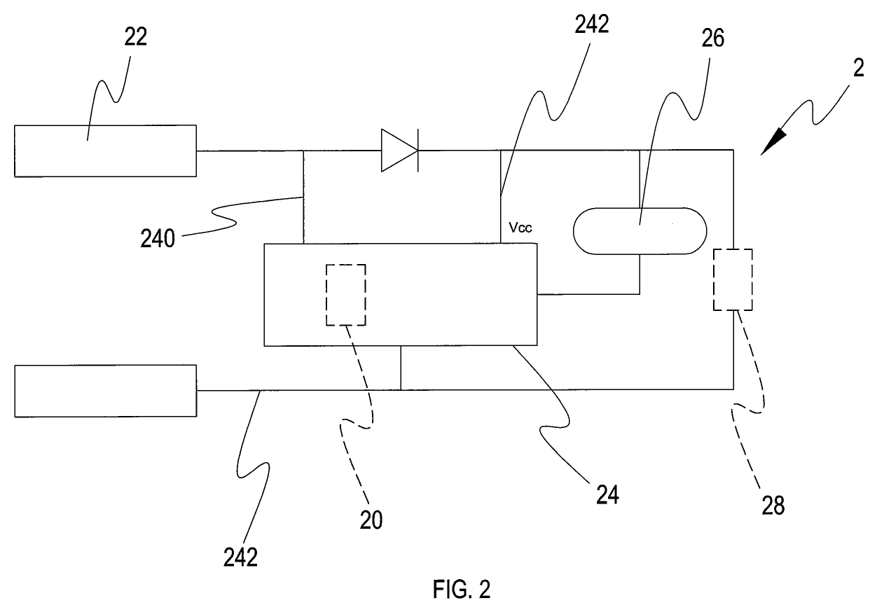

Referring to FIG. 1 and FIG. 2, it shows a schematic view of a state of the present invention which supplies a proper power specification to an electronic product and an internal schematic view of a chip management module of the present invention. As shown in the drawings, the present invention is an automated power supply which comprises primarily a power supply system 1 electrically connected with a chip management module 2 by a power connection port 3, such as a USB (Universal Serial Bus) interface, a Fire Wire interface, an e-SATA (Serial Advanced Technology Attachment) interface, an 1394A interface, an 1394B interface, an optic fiber interface or a LAN (Local Area Network). The chip management module 2 includes a data storage module 20, a transmission module 22 (e.g., a USB interface, a Fire Wire interface, an e-SATA interface, an 1394A interface, an 1394B interface, an optic fiber interface or a LAN), a protocol circuit module 24 and a power detecting module 26, wherein the data storage module 20 and the power supply system 1 form an electric loop to store a power specification data of a related electronic product 4, the transmission module 22, the power detecting module 26 and the protocol circuit module 24 form an electric loop, whereas the power detecting module 26, the transmission module 22 and the protocol circuit module 24 form an electric loop by which whether a voltage of a capacitor module 28 has reached to a rated value is detected. On the other hand, the protocol circuit module 24 includes at least one signal/power output/input pin 240 for transmitting an electric signal and a grounding pin 242; hence, a size of the chip management module 2 is largely reduced.

Moreover, the power supply system 1 is formed primarily by connecting a protocol transmission/receiving module 10, such as an MCU (Microprocessor Control Unit) or a customized controller, with a voltage conversion module 12, such as a DC (Direct Current)/DC converter or an AC (Alternating Current)/DC converter, wherein the protocol transmission/receiving module 10 forms an electric loop with the data storage module 20 to acquire the power specification data of the related electronic product 4, and then forms an electric connection with the voltage conversion module 12 to recharge the electronic product 4.

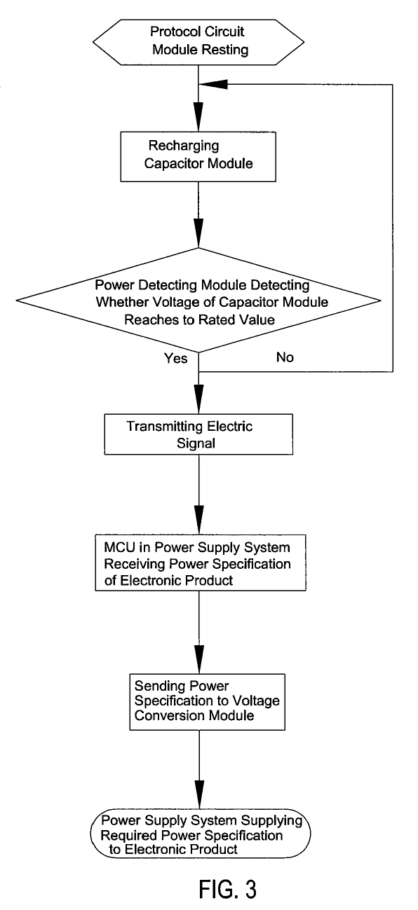

Referring to FIGS. 1 to 3, it shows a schematic view of a state of the present invention which supplies a proper power specification to an electronic product, an internal schematic view of a chip management module of the present invention and a flow diagram of a power supply of the present invention. As shown in the drawings, the power connection port 3 uses an USB interface as an example and the signal/power output/input pin 240 uses an 1-wire (2pin) as an example. The protocol circuit module 24 includes two pins which are the signal/power output/input pin 240 (1-wire) and the grounding pin 242, respectively. The data storage module 20 inside the system 1, whereas, stores the power specification data of the related electronic product 4, the signal/power output/input pin 240 of the protocol circuit module 24 is connected to the transmission module 22 and the power detecting module 26 forms a loop with the capacitor module 28. Therefore, the capacitor module 28 in the protocol circuit module 24 conducts recharging by a voltage difference between the pins. Before the power detecting module 26 has detected that the voltage of the capacitor module 28 reaches to the rated value, the system 1 will be resting. On the other hand, after the power detecting module 26 has detected that the voltage reaches to the rated value, the electric signal will be outputted by the protocol circuit module 24 through the transmission module 22. As electricity is sufficient to drive the protocol circuit module 24 to send out the one-time electric signal to the power supply system 1, when the electronic product 4 requires the power supply system 1 to supply electricity, the protocol circuit module 24 will send out the electric signal to the power supply system 1 through the signal/power output/input pin 240. In addition, after the protocol transmission/receiving module 10 in the power supply system 1 is aware of the power specification data needed by the electronic product 4, the power supply system 1 can transmit the proper power specification to the electronic product 4, which is able to reduce a requirement of an internal driving power and can also largely diminish the size of the chip and electric power consumption.

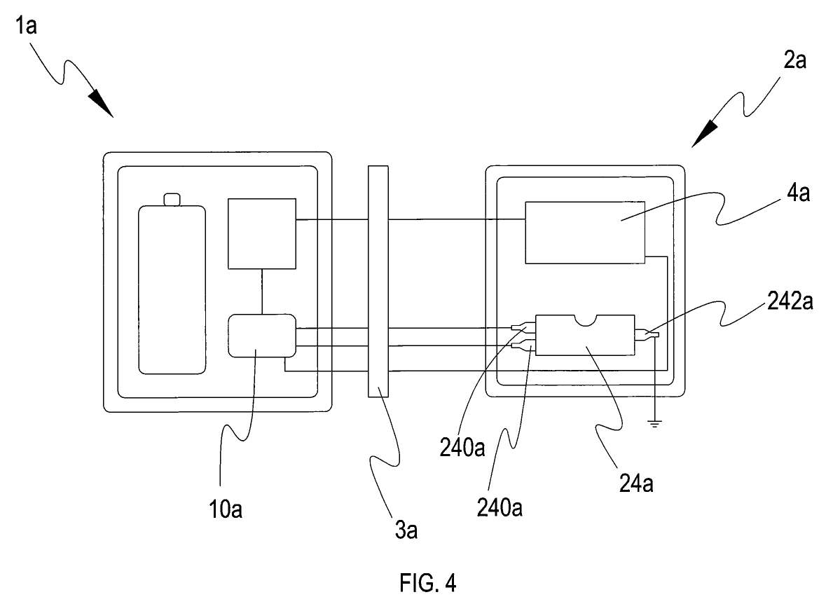

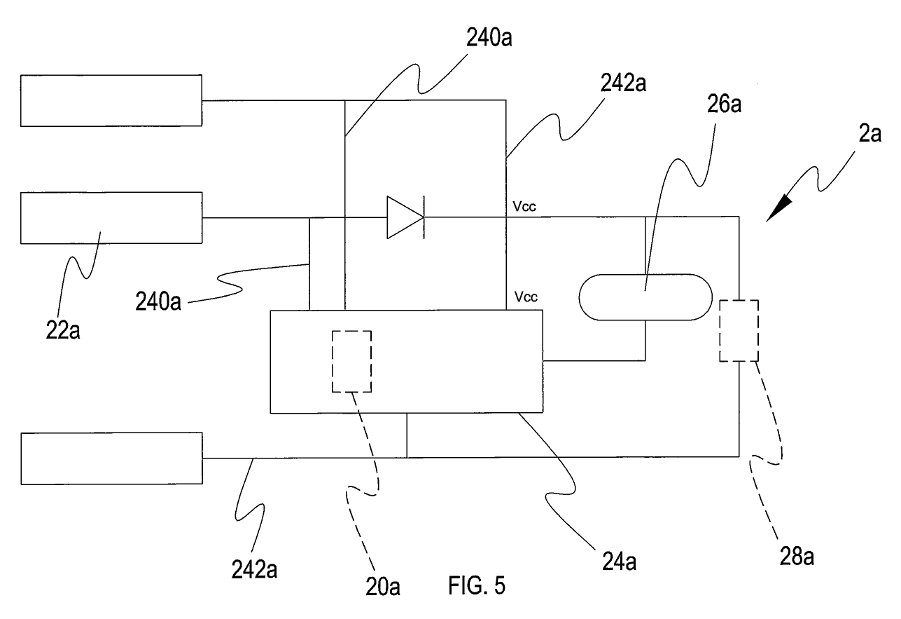

Referring to FIG. 4 and FIG. 5, it shows a schematic view of a state of another embodiment of the present invention which supplies a proper power specification to an electronic product; and an internal schematic view of a chip management module of another embodiment of the present invention, wherein the chip management module uses two signal/power output/input pins to proceed with signal transmission. As shown in the drawings, and also referring to FIG. 1 at a same time, the power connection port 3a uses a Fire Wire interface as an example and the signal/power output/input pins 240a use a 2-wire (3pin) as an example. The protocol circuit module 24a includes three pins which are two signal/power output/input pins 240a (2-wire) and one grounding pin 242a, and the two signal/power output/input pins 240a are connected with the protocol transmission/receiving module 10a; whereas, the data storage module 20a inside the system 1a stores the power specification data of the related electronic product 4a. The signal/power output/input pins 240a of the protocol circuit module 24a are connected with the transmission module 22a, and the power detecting module 26a forms a loop with the capacitor module 28a. Hence, the capacitor module 28a in the protocol circuit module 24a conducts recharging by the voltage difference between the pins. Before the power detecting module 26a has detected that the voltage of the capacitor module 28a reaches to the rated value, the system 1a will be resting. On the other hand, after the power detecting module 26a has detected that the voltage reaches to the rated value, the electric signal will be outputted by the protocol circuit module 24a through the transmission module 22a. As the electricity is sufficient to drive the protocol circuit module 24a to send out the one-time electric signal to the power supply system 1a, when the electronic product 4a requires the power supply system 1a to supply the electricity, the protocol circuit module 24a will send out the electric signal to the power supply system 1a through the signal/power output/input pins 240a. In addition, after the protocol transmission/receiving module 10a in the power supply system 1a is aware of the power specification data needed by the electronic product 4a, the power supply system 1a can transmit the proper power specification to the electronic product 4a, which is able to reduce the requirement of the internal driving power and can also largely diminish the size of the chip and the electric power consumption.

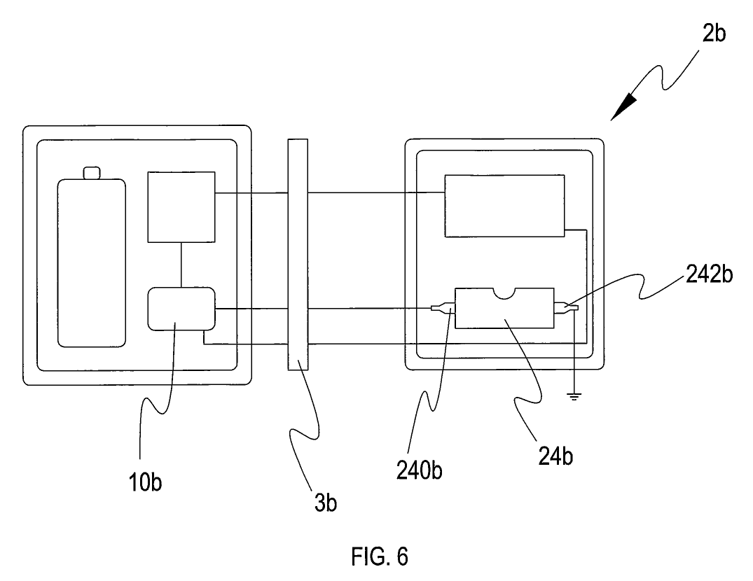

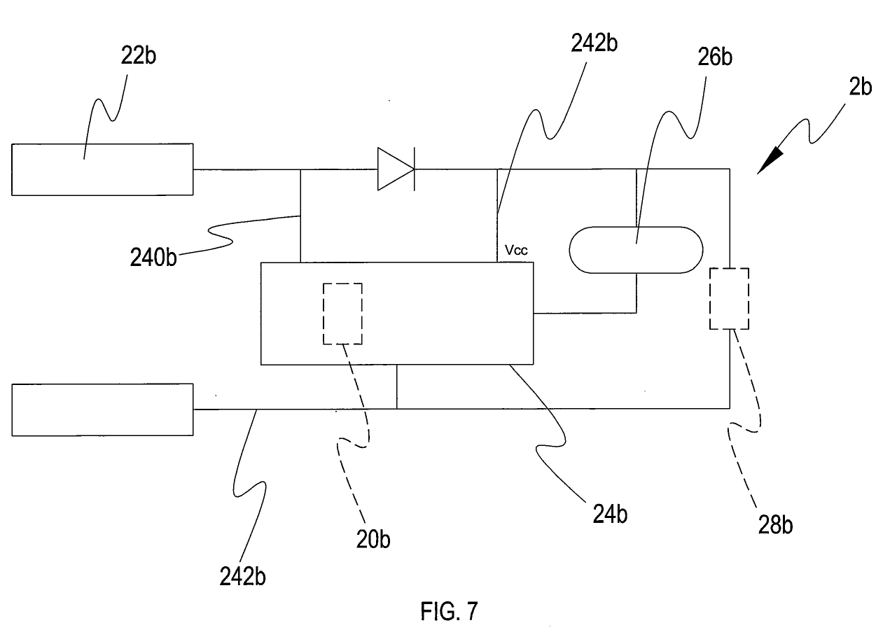

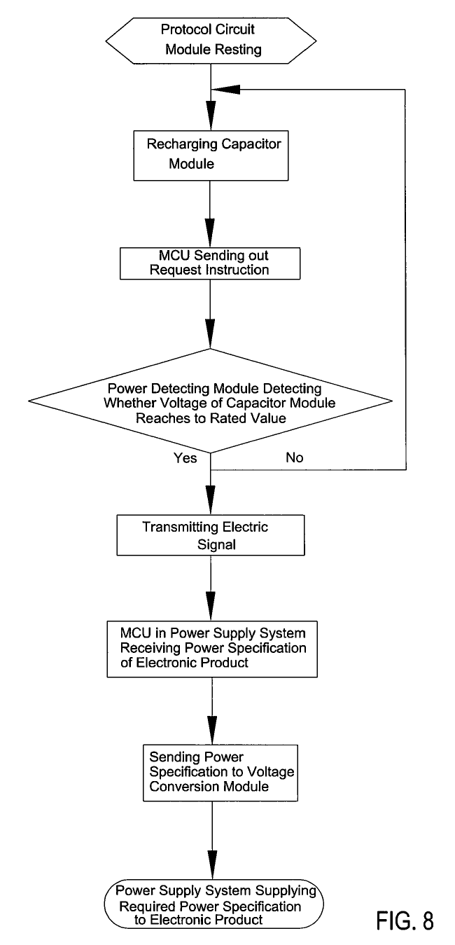

Referring to FIGS. 6 to 8, it shows a schematic view of a chip management module of still another embodiment of the present invention, wherein the chip management module responses to a protocol transmission/receiving module and outputs an electric signal; an internal schematic view of the chip management module in FIG. 6; and a flow diagram of FIG. 6. When the protocol transmission/receiving module 10b provides a signal to the protocol circuit module 24b in the chip management module 2b, there are two pins in the protocol circuit module 24b, which are the signal/power output/input pin 240b (1-wire) and the grounding pin 242b, respectively. Whereas, the signal/power output/input pin 240b of the protocol circuit module 24b is connected with the transmission module 22b, and the power detecting module 26b forms a loop with the capacitor module 28b. Therefore, the capacitor module 28b in the protocol circuit module 24b conducts recharging by the voltage difference between the pins. At this time, the protocol transmission/receiving module 10b will transmit the required signal to the protocol circuit module 24b. Before the power detecting module 26b has detected that the voltage of the capacitor module 28b reaches to the rated value, the system 1b will be resting. On the other hand, after the power detecting module 26b has detected that the voltage reaches to the rated value, the electric signal will be outputted by the protocol circuit module 24b through the transmission module 22b. As the electricity is sufficient to drive the protocol circuit module 24b to send out the one-time electric signal to the power supply system 1b, when the electronic product 4b requires the power supply system 1b to supply the electricity, the protocol circuit module 24b will send out the electric signal to the power supply system 1b through the signal/power output/input pins 240b; hence, the protocol circuit module 24b will output the electric signal required by the protocol transmission/receiving module 10b.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. An automated power supply comprising a power supply system which is provided with a power connection port electrically connected with a chip management module, the chip management module including a data storage module forming an electric loop with the power supply system and storing a power specification data of a related electronic product; a transmission module forming an electric loop with the power connection port; a protocol circuit module having at least one power output or input pin to transmit an electric signal and a voltage, and a grounding pin, and forming an electric loop with the transmission module; and a power detecting module forming an electric loop with the transmission module and the protocol circuit module to detect whether a voltage of a capacitor module has reached to a rated value.

2. The automated power supply according to claim 1, wherein the power supply system includes a protocol transmission or receiving module which forms an electric loop with the data storage module to acquire the power specification of the related electronic product; a voltage conversion module which is electrically connected with the protocol transmission or receiving module and recharges the electronic product.

3. The automated power supply according to claim 2, wherein the protocol transmission and receiving module is further an MCU (Microprocessor Control Unit) or a customized controller.

4. The automated power supply according to claim 2, wherein the voltage conversion module is further a DC (Direct Current) to DC converter or an AC (Alternating Current) to DC converter.

5. The automated power supply according to claim 1, wherein the power connection port is chosen freely from a USB (Universal Serial Bus) interface, a Fire Wire interface, an e-SATA (Serial Advanced Technology Attachment) interface, an 1394A interface, an 1394B interface, an optic fiber interface and a LAN (Local Area Network).

6. The automated power supply according to claim 1, wherein the transmission module is chosen freely from a USB interface, a Fire Wire interface, an e-SATA interface, an 1394A interface, an 1394B interface, an optic fiber interface and a LAN.
